(19) United States
(12) Patent Application Publication
(10) Pub. No.: US 2007/0222292 A1
(43) Pub. Date: Sep. 27, 2007

(54) Vehicle security apparatus and system

(75) Inventor: Toshio Shimomura, Chiryu-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/723,975

(22) Filed: Mar. 22, 2007

(30) Foreign Application Priority Data
Mar. 22, 2006 (JP) 2006-79158

(51) Int. Cl. B60R 25/04; G05B 19/00; B60R 25/10

(52) U.S. Cl. 307/10.3; 340/5.61; 340/426.11

(57) ABSTRACT

A vehicle security apparatus is equipped with an immobilizer ECU, a remote security ECU, a communication ECU, and the like. The immobilizer ECU controls prohibition and permission of a drive operation of an engine based upon an identification signal transmitted from an electronic key. The immobilizer ECU also controls the prohibition and permission of the drive operation of the engine based upon a remote set signal and a remote unset signal, which are transmitted from a base station. A remote immobilizer function for prohibiting the operation of the engine based on the identification signal is set until the remote unset signal is transmitted when the remote unset signal is transmitted from the base station, on condition that the travel of the vehicle is completed.

### CROSS REFERENCE TO RELATED APPLICATION

This application is based on and incorporates herein by reference Japanese Patent Application No. 2006-79158 filed on Mar. 22, 2006.

This application is related to the following two U.S. patent applications, which are filed by the same inventor and assignee as this application:

102704-US claiming priority to JP application No. 2006-79159 filed Mar. 22, 2006; and

102736-US claiming priority to JP application No. 2006-79157 filed Mar. 22, 2006.

### FIELD OF THE INVENTION

The present invention relates to a vehicle security apparatus and a vehicle security system, and particularly to an apparatus and a system that prevents continued use of a stolen vehicle.

### BACKGROUND OF THE INVENTION

Conventionally, vehicle security systems have been utilized in many vehicles. That is, in the case that vehicles are stolen with authorized keys, the vehicle security systems prevent illegal uses of the stolen vehicles by causing the stolen vehicles to be not drivable.

In these vehicle security systems, when a vehicle is stolen with an authorized key, an owner or an authorized user of this stolen vehicle reports a vehicle theft to a base station. The base station transmits a signal indicative of a drive prohibition request for an engine of the stolen vehicle in a wireless communication manner. Then, the stolen vehicle, which receives this signal indicative of the drive prohibition request, prohibits the drive operation of the engine (for example, JP 2003-146185A).

If the engine is in operation when the drive operation is to be prohibited, the vehicle security system forcibly stops the engine operation and prohibits restarting of the engine. Alternatively, the vehicle security system only prohibits the restarting of the engine without forcibly stopping the engine operation from the standpoint of safety. This control may however cause disturbance in traffic flow, because the engine operation of the stolen vehicle is prohibited when the engine stops at a traffic light or the engine stalls for some reason.

### SUMMARY OF THE INVENTION

The invention has therefore an object to provide a vehicle security apparatus and a vehicle security system that does not cause disturbance in traffic flow.

A vehicle security system is comprised of a vehicle security apparatus, an electronic key and a communication apparatus. The vehicle security apparatus is capable of communicating with the electronic key and the communication apparatus. The electronic key transmits a specific identification signal, and the communication apparatus is located at a remote place and transmits drive request signals indicative of a drive prohibition request and a drive permission request to a drive power apparatus of a vehicle.

The vehicle security apparatus is comprised of a key communication unit, a remote communication unit, a travel condition detecting unit and a control unit. The key communication unit communicates with the electronic key. The remote communication unit communicates with the communication apparatus located at the remote place. The travel condition detecting unit detects a travel condition of the vehicle. The control unit controls prohibition and permission of a drive operation of the power apparatus based upon the identification signal transmitted to the key communication means, the drive request signal transmitted to the remote communication means, and the travel condition of the vehicle. The control means further executes a remote drive prohibition control operation for prohibiting drive permission of the power apparatus based upon the identification signal until the drive request signal indicating the drive permission request is transmitted to the remote communication unit based on an execution condition that a detection result of the travel condition detecting unit indicates a completion of the traveling operation of the vehicle, when the drive request signal indicating the drive permission request is transmitted to the remote communication unit.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing schematically a vehicle security system according to an embodiment of the invention; and

FIG. 2 is a time chart showing operations of the vehicle security apparatus shown in FIG. 1.

### DETAILED DESCRIPTION OF THE PREFERRED EMBODIMENTS

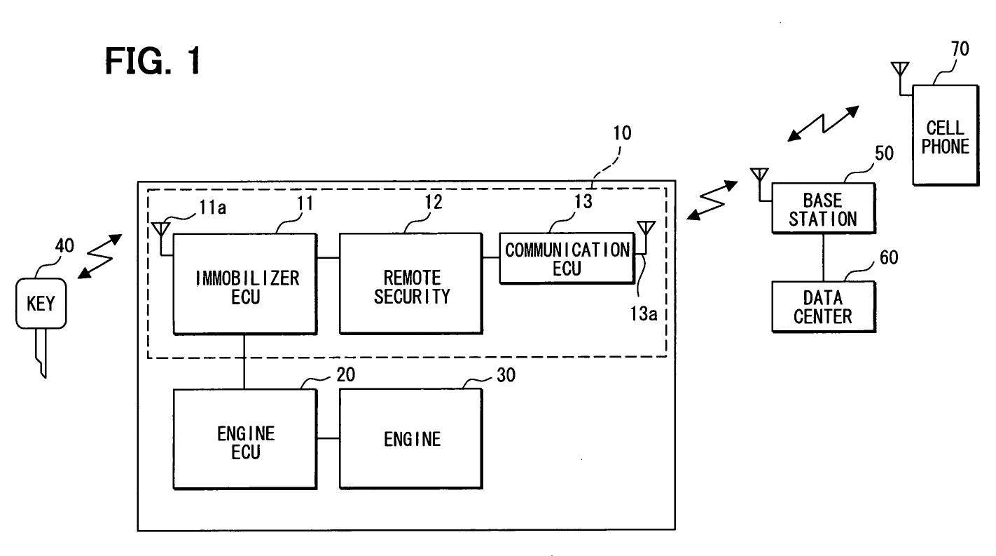

Referring to FIG. 1, a vehicle security system includes a vehicle security apparatus 10, an engine electronic control unit (ECU) 20 for an engine 30, a key 40, a base station 50, a data center 60, a cellular phone 70, and the like.

The vehicle security apparatus 10 is provided in a vehicle and includes an immobilizer ECU 11, a remote security ECU 12, a communication ECU 13, and the like.

The immobilizer ECU 11 is a local control unit (control means), and includes a microcomputer. The immobilizer ECU 11 is provided with: a memory such as a ROM, a RAM, and an EEPROM; either an interface circuit or a data transfer bus line; an antenna 11a; and the like. The antenna 11a is for radio communication with the key 40, which is an electronic key. It should be understood that, although not shown, power supply conditions (IG, ACC, OFF) can be detected by the immobilizer ECU 11.

The key 40 of the vehicle is equipped with a communication apparatus unit (not shown) having a specific identification signal (ID code) in a key head. The communication apparatus unit responds to a calling signal sent from the antenna 11a, and transmits a response signal containing the identification signal. Also, the antenna 11a has been provided in the vicinity of a key slot (not shown) used to ignite the engine 30, and a switch (not shown) has been provided inside the key slot. When the key 40 is inserted into the key slot, the switch is turned on, so that a radio communication operation is performed between the communication apparatus unit of the key 40 and the antenna 11a.

The immobilizer ECU 11 outputs a drive signal to the engine ECU 20 based upon an identification signal transmitted from the key 40, and a remote set signal, and also a remote unset signal which are outputted from the remote security ECU 12. The drive signal indicates to permit, or prohibit a driving operation of the engine 30. It should be noted that such an operation to output the drive signal indicating the permission or the prohibition of driving the engine 30 to the engine ECU 20 will be referred to as a set/unset of an immobilizer function. It should also be understood that such an operation to output a drive signal indicating a permission or prohibition of driving the engine 30 to the engine ECU 20 based upon a remote set signal or a remote unset signal outputted for the remote security ECU 12 will be referred to as a set/unset of a remote immobilizer function.

Specifically, when the immobilizer ECU 11 sets the immobilizer, the immobilizer ECU 11 outputs such a drive signal indicating the drive prohibition of the engine 30 to the engine ECU 20 in order to prohibit the drive operation of the engine 30. Then, when the immobilizer ECU 11 unsets the immobilizer, the immobilizer ECU 11 outputs such a drive signal indicating the drive permission of the engine 30 to the engine ECU 20 in order to permit the drive operation of the engine 30.

Also, when the immobilizer ECU 11 sets the remote immobilizer, even if the identification signal is transmitted from the key 40, the immobilizer ECU 11 outputs such a drive signal indicating the drive prohibition of the engine 30 to the engine ECU 20 in order to maintain the drive prohibition of the engine 30. Thus, setting of the remote immobilizer corresponds to a remote drive prohibition control operation for prohibiting a drive permission of a drive power apparatus based upon an identification signal until a drive request signal indicative of a drive permission request is transmitted to a remote communication means.

Then, when the immobilizer ECU 11 unsets the remote immobilizer, if the identification signal is transmitted from the key 40, the immobilizer ECU 11 outputs such a drive signal indicating the drive permission of the engine 30 to the engine ECU 20 in order to permit driving of the engine 30.

Furthermore, the immobilizer ECU 11 has a set-wait state (wait state) of the remote immobilizer function, which corresponds to such a state that the immobilizer ECU 11 has received only a remote set signal outputted from the remote security ECU 12. It should also be noted that this wait state of the remote immobilizer function is referred to as a wait state of the remote immobilizer.

The remote security ECU 12 is also a remote control unit (control means), and includes a microcomputer. The remote security ECU 12 is equipped with such a memory as a ROM, a RAM, and an EEPROM; and either an interface circuit or a data transfer bus line; and the like. The remote security ECU 12 outputs a remote set signal, and a remote unset signal from the communication ECU 13 to the immobilizer ECU 11. The remote set signal corresponds to a drive request signal which requests to prohibit a driving operation of the power apparatus of the vehicle. The remote unset signal corresponds to a drive request signal which requests to permit a driving operation of the power apparatus of the vehicle.

The communication ECU 13 is a remote communication unit and includes a microcomputer. The communication ECU 13 is equipped with such a memory as a ROM, a RAM, and an EEPROM; and either an interface circuit or a data transfer bus line; and an antenna 13a which is for radio communication with the base station 50 corresponding to a communication apparatus located at a remote place. The communication ECU 13 outputs a remote set signal and a remote unset signal, which are transmitted from the base station 50, to the remote security ECU 12. It should also be noted that, as this communication ECU 13, any sorts of control units may be employed which are connectable with a wireless phone line and the Internet line. A vehicle-mounted phone may be alternatively employed.

The engine ECU 20 includes a microcomputer. The engine ECU 20 is equipped with such a memory as a ROM, a RAM, and an EEPROM; and either an interface circuit or a data transfer bus line; and the like. Only in a case that the immobilizer ECU 11 unsets the immobilizer, that is, when a drive signal indicative of drive permission of engine 30 is outputted, the engine ECU 20 starts operations of its starter motor, fuel injection device and ignition device based upon a starting signal supplied from an ignition switch (not shown). As a result, while the starter motor is driven, fuel is injected to the engine 30 and ignition plugs are ignited so as to start the engine 30 (driving operation is permitted).

Also, in a case that the immobilizer ECU 11 sets the immobilizer, that is, when a drive signal indicative of drive prohibition of engine 30 is outputted, the engine ECU 20 does not start operations of its starter motor, fuel injection device, and ignition device. That is, the engine ECU 20 does not start the engine 30 (driving operation is prohibited).

The base station 50 is a communication apparatus located at a remote place. The base station 50 is for radio communication with the communication ECU 13, the cellular phone 70, and the like in a wireless manner. The base station 50 is furthermore connected to a data center 60, which manages a large number of vehicle information.

In this vehicle security system, when a vehicle is stolen, a user of the vehicle communicates with the base station 50 by the cellular phone 70. As a result, the user reports a car theft to the data center 60. Then, the data center 60, which receives this report of the car theft, outputs a remote set signal to the base station 50. The base station 50, which receives this remote set signal, transmits the remote set signal to the vehicle (communication ECU 13). Also, in a case that a stolen vehicle or the like is found out, the user of the vehicle communicates with the base station 50 by operating the cellular phone 70, so that the user reports the discovery of the stolen vehicle to the data center 60. The data center 60, which receives the report of the discovery of the stolen vehicle, outputs a remote unset signal to the base station 50. The base station 50, which receives this remote unset signal, transmits the remote unset signal to the vehicle (communication ECU 13).

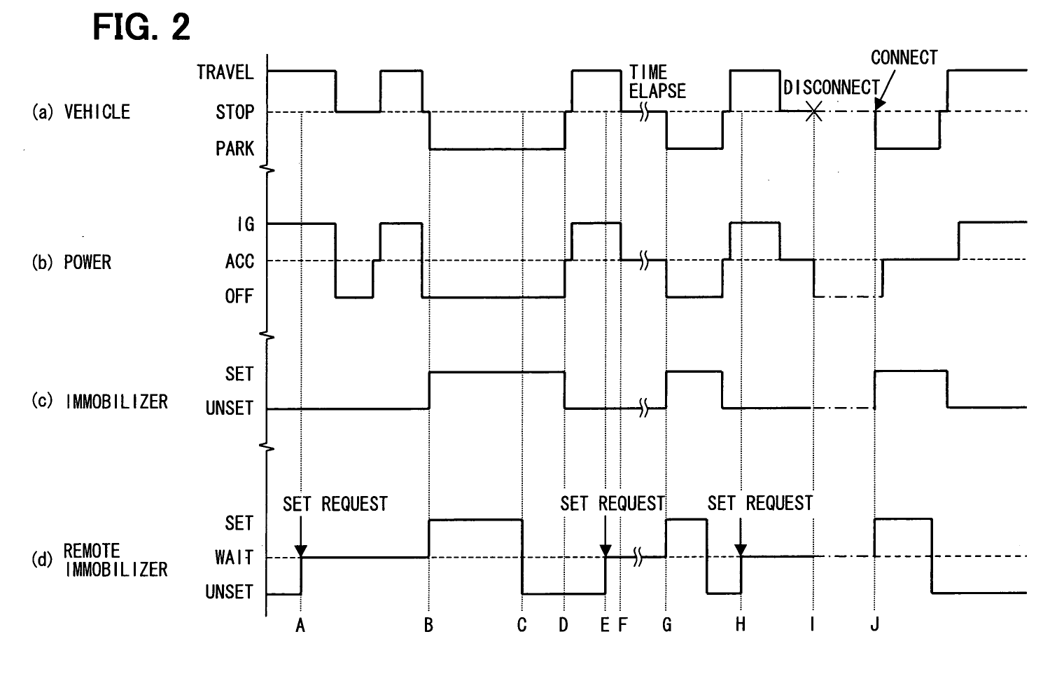

In operation, if the vehicle is stolen together with the key 40 by an unauthorized person and the key 40 is inserted into the key slot, then the immobilizer ECU 11 checks whether or not the inserted key is the authorized one based upon the identification signal sent from the key 40. When the immobilizer ECU 11 determines that the inserted key is the authorized one, the immobilizer ECU 11 unsets the immobilizer for a time period from a starting point (left end) in (c) of FIG. 2 up to a time point A. As a result, as represented in such a time period from starting points (left ends) in (a) and (b) of FIG. 2 up to the point A, the electric power supply state of the vehicle is maintained with the key 40 in the ignition (IG) position. Thus, the vehicle is under travel condition by that the unauthorized person having the key 40. As a result, the vehicle may be freely used in an illegal manner by the unauthorized person during this time period.

Under such a circumstance, in the case that the vehicle is stolen, the authorized user of this vehicle communicates with the base station 50 by operating the cellular phone 70 in order that the authorized user notifies a car theft to the data center 60. The data center 60, which receives this report of the car theft, outputs a remote set signal to the base station 50. As shown in the point A in (d) of FIG. 2, the base station 50, which receives this remote set signal, transmits the remote set signal to the vehicle (communication ECU 13) so as to request to set the remote immobilizer.

The communication ECU 13 receives the remote set signal via the antenna 13a. Then, the communication ECU 13 outputs the received remote set signal to the remote security ECU 12. The remote security ECU 12 outputs the received remote set signal to the immobilizer ECU 11.

In the case that the remote set signal is outputted from the remote security ECU 12, while the immobilizer ECU 11 unsets the immobilizer based upon the identification signal of the key 40, the immobilizer ECU 11 maintains unsetting of the immobilizer. That is, as shown from the point A to a time point B in (c) and (d) of FIG. 2, the immobilizer ECU 11 maintains unsetting of the immobilizer and brings the remote immobilizer to a wait state, so that the immobilizer ECU 11 prohibits to output the drive signal indicating the drive prohibition of the engine 30 to the engine 20.

As a consequence, as represented in a time period from the point A to the point B in (a) and (b) of FIG. 2, even in a case that the vehicle is stopped and the power supply state becomes either ACC or OFF, the immobilizer ECU 11 maintains unsetting of the immobilizer and outputs the drive signal indicating the drive permission of the engine 30 to the engine ECU 20. As a result, the vehicle is brought into a travelable state.

When the immobilizer ECU 11 outputs the drive signal indicating the drive permission of the engine 30 to the engine ECU 20 based upon the identification signal of the key 40, there are many possibilities that the vehicle is under traveling operation. As a consequence, in a case that while the immobilizer ECU 11 unsets the immobilizer based upon the identification signal of the key 40, the remote set signal is outputted, the immobilizer ECU 11 maintains unsetting of the immobilizer and also the immobilizer ECU 11 outputs the drive signal indicating the drive permission of the engine 30 to the engine ECU 20. As a result, when the vehicle is driven on the travel lane, the immobilizer ECU 11 avoids that the engine 30 is brought into the drive prohibition, so that the immobilizer ECU 11 can avoid that a traffic flow is disturbed. That is, in a case that the engine 30 of the stolen vehicle breaks down, or the engine 30 is stopped when the vehicle is stopped under signal waiting condition, the immobilizer ECU 11 can avoid that the engine 30 is brought into the drive prohibition, so that the immobilizer ECU 11 can avoid that the traffic flow is disturbed.

In a case that while the immobilizer ECU 11 unsets the immobilizer based upon the identification signal of the key 40, the remote set signal is outputted, the immobilizer ECU 11 maintains unsetting of the immobilizer, and also, the immobilizer ECU 11 outputs the drive signal indicating the drive permission of the engine 30 to the engine ECU 20. As a result, even when an erroneous operation of the remote immobilizer happens to occur, for example even when the remote unset signal is erroneously transmitted, the immobilizer ECU 11 can avoid that the engine 30 is brought into the drive prohibition.

As shown from the point A to the point B in (c) and (d) of FIG. 2, in the case that the immobilizer ECU 11 maintains unsetting of the immobilizer and brings the remote immobilizer into a wait state, when a remote unset signal is outputted from the remote security ECU 12, it is preferable that this wait state is released.

Next, a case that the immobilizer ECU 11 sets the engine 30 to be a drive prohibition state is described. That is, a case that the immobilizer ECU 11 sets both the immobilizer function and the remote immobilizer function is described.

In the case that as indicated from the point A to the point B in (d) of FIG. 2, the immobilizer ECU 11 receives a remote set signal from the base station 50 via the remote security ECU 12 so as to bring the remote immobilizer into a wait state, if the key 40 is pulled out from the key slot; as shown in (a) and (b) of FIG. 2, the power supply state is turned off; and the vehicle state becomes a parking state. Then the immobilizer ECU 11 sets the immobilizer and the remote immobilizer. That is, when the immobilizer ECU 11 determines that the key 40 is pulled out from the key slot and the identification signal from the key 40 is not supplied and thus the authorized key 40 is not in the key slot, this immobilizer ECU 11 sets both the immobilizer and the remote immobilizer. When the immobilizer is set, the immobilizer ECU 11 outputs the drive signal indicating the drive prohibition of the engine 30 to the engine ECU 20 in order to prohibit the drive operation of the engine 30.

Then, while the immobilizer ECU 11 sets both the immobilizer and the remote immobilizer (for instance, time period from point B to point C in (d) of FIG. 2), even when the authorized key 40 is inserted in the key slot, the immobilizer ECU 11 does not unset the immobilizer, but maintains setting of the immobilizer. This operation is required in order to avoid that the vehicle is continuously used in the illegal manner by the unauthorized person.

When a stolen vehicle is found out and the authorized user of this stolen vehicle is under such a condition that this user is able to drive the vehicle, the authorized user of the vehicle communicates with the base station 50 by operating the cellular phone 70, so that the authorized user reports discovery of the stolen vehicle to the data center 60. The data center 60, which receives the discovery of the stolen vehicle, outputs a remote unset signal to the base station 50. The base station 50, which receives this remote unset signal, transmits the remote unset signal to the vehicle (communication ECU 13) in order to issue a remote immobilizer unset request.

The communication ECU 13 receives the remote unset signal via the antenna 13a. Then, the communication ECU 13 outputs the received remote unset signal to the remote security ECU 12. The remote security ECU 12 outputs the received remote unset signal to the immobilizer ECU 11.

In the case that the remote unset signal is outputted from the remote security ECU 12, as shown at a time point C in (d) of FIG. 2, the immobilizer ECU 11 unsets the remote immobilizer. While the immobilizer ECU 11 sets the immobilizer based upon the identification signal of the key 40, the immobilizer ECU 11 maintains setting of the immobilizer even in a case that the remote unset signal is outputted from the remote security ECU 12 and thus the immobilizer ECU 11 unsets the remote immobilizer. That is, as shown from the point C to a time point D in (c) and (d) of FIG. 2, even when the immobilizer ECU 11 unsets the remote immobilizer, since the immobilizer ECU 11 maintains setting of the immobilizer, the immobilizer ECU 11 maintains to outputs the drive signal indicating the drive prohibition of the engine 30 to the engine ECU 20. Thus, the vehicle is brought into a travel-prohibited state in a case that the authorized key 40 is not present.

In this case, for instance, the immobilizer ECU 11 unsets the immobilizer in connection with unsetting of the remote immobilizer. If the immobilizer ECU 11 unsets the immobilizer in connection with unsetting of the remote immobilizer, the immobilizer ECU 11 outputs a drive signal indicating the drive permission of the engine 30 to the engine ECU 20. As a consequence, if the immobilizer ECU 11 unsets the immobilizer in connection with unsetting of the remote immobilizer, then the vehicle can be traveled even if the user dose not have the authorized key 40. As a consequence, while the immobilizer ECU 11 sets the immobilizer based upon the identification signal of the key 40, even in a case that the remote unset signal is outputted from the remote security ECU 12 so as to unset the remove immobilizer, the immobilizer ECU 11 maintains to output the drive signal indicating the drive prohibition of the engine 30 to the engine ECU 20. As a consequence, it is possible to prevent that the vehicle is used in the illegal manner by the unauthorized person, so that the security characteristic can be improved.

Then, if the key 40 is inserted into the key slot when the remote immobilizer is unset (for example, between point C and point D in (d) of FIG. 2), the immobilizer ECU 11 checks whether or not the inserted key 40 is the authorized key based upon the identification signal transmitted from the key 40. When the immobilizer ECU 11 determines that the inserted key is the authorized one as represented in the point D in (c) of FIG. 2, the immobilizer ECU 11 unsets the immobilizer.

In the case that the remote immobilizer function is set, in order to avoid that a traffic flow is disturbed, it is required that the travel of the vehicle is surely finished. This is not such a case that the engine 30 is turned off at the time of temporary stop of the vehicle, or the engine stalls. Accordingly, it is assumed that the immobilizer ECU 11 sets the remote immobilizer function on condition that a state of ACC has elapsed for a predetermined time period, as a setting condition of the remote immobilizer function.

Firstly, in the case that the immobilizer ECU 11 sets the engine 30 to the drive permission state (immobilizer is unset), as shown at a time point E in (d) of FIG. 2, when the immobilizer ECU 11 receives a remote immobilizer setting request (SR), the immobilizer ECU 11 maintains unsetting of the immobilizer and sets the remote immobilizer to a wait state, so that the immobilizer ECU 11 prohibits to output the drive signal indicating the drive prohibition of the engine 30 to the engine ECU 20. That is, in the case that a remote set signal is outputted via the communication ECU 13 and the remote security ECU 12 from the base station 50 based upon a report of a car theft made by the authorized user of the vehicle, the immobilizer ECU 11 brings the remote immobilizer to the wait state.

Then, the immobilizer ECU 11 detects a power supply condition, and detects a drive condition of the vehicle, depending upon whether or not a predetermined time has elapsed after the power supply condition has become ACC (accessory position of an ignition switch). Thus, the immobilized ECU 11 operates as a drive condition detecting means. Also, the immobilizer ECU 11 sets the remote immobilizer if under wait state of the remote immobilizer, as represented from a time point E to a time point F in (a) and (b) of FIG. 2, the vehicle state is changed from the travel state to the stop state; and the power supply condition is changed from IG to ACC. The immobilizer ECU 11 furthermore sets the remote immobilizer as shown from the point F to a time point G in (a) and (b) of FIG. 2, when ACC of the power supply condition has elapsed for a predetermined time. That is, if the immobilizer ECU 11 regards such a fact that the state of ACC has passed for a predetermined time as a completion of the vehicle traveling operation, then the immobilizer ECU 11 sets the remote immobilizer and also the immobilizer, so that the immobilizer ECU 11 outputs the drive signal indicating the drive prohibition of the engine 30 to the engine ECU 20.

As previously described, under the wait state of the remote immobilizer, at a time instant when the state of ACC has passed for a predetermined time, the immobilizer ECU 11 sets both the remote immobilizer and the immobilizer. The he immobilizer ECU 11 further outputs the drive signal indicating the drive prohibition of the engine 30 to the engine ECU 20. As a result, it is possible to avoid that the traffic flow is disturbed.

In addition to the above condition, as the conditions for setting the remote immobilizer function, the following setting conditions may be conceived: the immobilizer has been set based upon the identification signal of the key 40; a time is defined within a predetermined time period after the immobilizer has been set based upon the identification signal of the key 40; a car theft alarm is set by turning off the engine 30; a car theft occurs; a steering lock is set; a battery is connected/disconnected, and the like.

Firstly, a description is made of the following case: That is, such an operation that the immobilizer has been set based upon the identification signal of the key 40 is employed as the setting condition for the remote immobilizer function. In the case that such an operation that the immobilizer has been set based upon the identification signal of the key 40, namely, the authorized key 40 has been pulled out from the key slot is employed as the setting condition of the remote immobilizer function, the immobilizer ECU 11 detects whether or not the immobilizer has been set based upon the identification signal of the key 40 so as to detect a drive condition of the vehicle.

When a remote set signal is outputted from the remote security ECU 12, the immobilizer ECU 11 checks whether or not the immobilizer has been set based upon the identification signal of the key 40. Then, when the immobilizer ECU 11 determines that the immobilizer has not been set, the immobilizer ECU 11 brings the remote immobilizer to the wait state. When the immobilizer ECU 11 determines that the immobilizer has been set, the immobilizer ECU 11 sets the remote immobilizer.

A case that the immobilizer has been set based upon the identification signal of the key 40 corresponds to a case that the authorized key has been pulled out from the key slot. In this case, it is very likely that driving of the vehicle is accomplished and the vehicle is not traveling on the drive lane. As a consequence, as the condition for setting the remote immobilizer function, a fact that the immobilizer has been set based upon the identification signal of the key 40 is applied. As a result, it is possible to avoid that the traffic flow is disturbed.

Next, the following setting condition will now be described: that is, a fact that a predetermined time has passed after the immobilizer was set based upon the identification signal of the key 40 is employed as the setting condition of the remote immobilizer function. In the case that such a fact that a predetermined time has passed after the immobilizer was set based upon the identification signal of the key 40 is employed as the setting condition of the remote immobilizer function, the immobilizer ECU 11 detects whether or not the predetermined time has elapsed after the immobilizer was set based upon the identification signal of the key 40 so as to detect a drive condition of the vehicle.

When a remote set signal is outputted from the remote security ECU 12, the immobilizer ECU 11 checks whether or not the predetermined time has passed after the immobilizer was set based upon the identification signal of the key 40. In the case that the immobilizer ECU 11 determines that the predetermined time has not yet passed after the immobilizer was set, the immobilizer ECU 11 sets the remote immobilizer to a wait state. In the case that the immobilizer ECU 11 determines that the predetermined time has passed after the immobilizer was set, the immobilizer ECU 11 sets the remote immobilizer.

Since a condition that the predetermined time has passed after the immobilizer was set based upon the identification signal of the key 40 is applied as the setting condition of the remote immobilizer function, the remote immobilizer function can be further surely set when the drive operation of the vehicle is accomplished. As a result, it is possible to avoid that the traffic flow is disturbed.

Also, recently, as theft preventing apparatuses (not shown) of vehicles, such car theft preventing apparatuses are commercially available by which car theft alarms are sounded (produced) when a car theft is sensed. This car theft preventing apparatus sets a car theft alarm after a predetermined time has elapsed when an engine was turned off. This predetermined time is nearly equal to such a time which requires that a user opens a car door, and takes off the car, and then closes the car door. As a consequence, when the car theft alarm is set in the car theft preventing apparatus, it is possible to regard a drive operation of the vehicle as a completion. Under such a circumstance, this car theft preventing apparatus may be applied to the present embodiment, and setting of the car theft alarm by turning off the engine may be employed as the setting condition of the remote immobilizer function. The immobilizer ECU 11 detects whether or not the car theft alarm has been set so as to detect a drive condition of the vehicle.

In the case that setting of the car theft alarm by turning off the engine is employed as the setting condition of the remote immobilizer function, when a remote set signal is outputted from the remote security ECU 12, the immobilizer ECU 11 checks whether or not the car theft warning of the car theft preventing apparatus has been set. Then, when the immobilizer ICU 11 determines that the car theft alarm has not been set, the immobilizer ECU 11 sets the remote immobilizer to the wait state. When the immobilizer ECU 11 determines that the car theft alarm has been set, the immobilizer ECU 11 sets the remote immobilizer. As previously described, since the condition for setting the remote immobilizer function is also employed as setting of the car theft waning by turning off the engine, when the drive operation of the vehicle is surely ended. As a result, it is possible to avoid that the traffic flow is disturbed.

Also, when the above car theft preventing apparatus is applied to the present embodiment, also in a case that this car theft preventing apparatus produces the car theft alarm, it is possible to regard the drive operation of the vehicle as the completion. Under such a circumstance, this car theft preventing apparatus may be applied to the present embodiment, and the generation of the car theft alarm may be alternatively employed as the setting condition of the remote immobilizer function. The immobilizer ECU 11 detect whether or not the car theft alarm is generated so as to detect a drive condition of the vehicle.

In a case that a production of a car theft warning is employed as the setting condition of the remote immobilizer function, when a remote set signal is outputted from the remote security ECU 12, the immobilizer ECU 11 checks whether or not the car theft warning of the car theft preventing apparatus has been generated. Then, when the immobilizer ECU 11 determines that the car theft alarm has not been generated, the immobilizer ECU 11 sets the remote immobilizer to a wait state. When the immobilizer ECU 11 determines that the car theft alarm has generated, the immobilizer ECU 11 sets the remote immobilizer. As previously described, since the condition for setting the remote immobilizer function is also employed as the generation of the car theft warning, when the drive operation of the vehicle is surely ended, the remote immobilizer function can be further surely set. As a result, it is possible to avoid that the traffic flow is disturbed.

Also, recently, as the car theft preventing apparatuses (not shown) for the vehicles, there is such a car theft prevention apparatus that when a key is pulled out from a key slot, a steering wheel is locked. When a steering wheel locking condition is set in the car theft preventing apparatus, since the key has been pulled out, it is possible to be regarded as such a fact that a drive operation of the vehicle is ended. As a consequence, while this car theft presenting apparatus may be applied to the present embodiment, setting of this steering wheel locking operation may be employed as the setting condition of the remote immobilizer function. The immobilizer ECU 11 detects a drive condition of the vehicle by checking whether or not the steering wheel locking state is set.

In the case that setting of the steering wheel locking operation is employed as the setting condition of the remote immobilizer function, when a remote set signal is outputted from the remote security ECU 12, the remote immobilizer ECU 11 checks whether or not the steering wheel locking state has been set. When the immobilizer ECU 11 determines that the steering wheel locking state is not set, the immobilizer ECU 11 sets the remote immobilizer to a wait state. When the immobilizer ECU 11 determines that the steering wheel locking state has been set, the immobilizer ECU 11 sets the remote immobilizer. Since the condition for setting the remote immobilizer function is also employed as setting of the steering wheel locking operation, when the drive operation of the vehicle is surely ended, the remote immobilizer function can be set. As a result, it is possible to avoid that the traffic flow is disturbed.

Also, another example will now be described. That is, while connecting/disconnecting of a battery (condition of battery) is employed as the setting condition of the remote immobilizer function, the immobilizer ECU 11 sets the remote immobilizer function. Firstly, when the immobilizer ECU 11 sets the engine 30 to the drive permission (namely, when immobilizer is unset), as shown at a time point H in (d) of FIG. 2, when the immobilizer ECU 11 receives a remote immobilizer setting request (SR), the immobilizer ECU 11 maintains unsetting of the immobilizer and sets the remote immobilizer to the wait state in order to prohibit outputting of the drive signal indicating the drive prohibition of the engine 30 to the engine ECU 20. That is, in a case that a remote set signal is outputted from the base station 50 via the communication ECU 13 and the remote security ECU 12 based upon a car theft report issued from the authorized user of the vehicle, the immobilizer ECU 11 sets the remote immobilizer to the wait state (time period from point H to point I in (d) of FIG. 2). It should also be noted that while the immobilizer ECU 11 detects a condition of the battery, the immobilizer ECU 11 detects a drive condition of the vehicle by checking whether or not the battery is disconnected from the vehicle, and thereafter, the disconnected battery is again connected to the vehicle.

Then, when the battery is disconnected from the vehicle as indicated at a time point I in (a) of FIG. 2 under the wait state of the remote immobilizer, and furthermore, the battery is connected to the vehicle as shown at a time point J in (a) of FIG. 2, the immobilizer ECU 11 sets both the immobilizer and the remote immobilizer as represented at a time point J in (c) and (d) of FIG. 2. That is, the immobilizer ECU 11 regards the drive operation of the vehicle as the completion thereof by checking that the battery is connected/disconnected to the vehicle, so that the immobilizer ECU 11 sets the remote immobilizer and sets the immobilizer. As a result, the immobilizer ECU 11 outputs the drive signal indicating the drive prohibition of the engine 30 to the engine ECU 20.

As previously described, under the waiting condition of the remote immobilizer, at the time when the battery is connected/disconnected, the immobilizer ECU 11 sets both the remote immobilizer and the immobilizer, and then outputs the drive signal for representing the drive prohibition of the engine 30 to the engine ECU 20. Thus, when the drive operation of the vehicle is surely ended, the remote immobilizer function can be set. As a result, it is possible to avoid that the traffic flow is disturbed.

Although the present embodiment has been described with reference to an example that the remote set signal and the remote unset signal are transmitted from the base station 50. If the remote set signal and the remote unset signal may be transmitted from such a communication apparatus which is located at a remote place, and transmits such drive request signals, then the object of the invention may be achieved. These drive request signals may indicate a drive prohibition request and a drive permission request as to the engine 30 of the vehicle.

Also, in the present embodiment, the key 40 operates as a mechanical key and an electronic key that transmits its identification signal. However, for example, a portable device such as a smart key may be alternatively employed, while the portable device may resends a response signal containing an identification signal (ID code) in response to a request signal transmitted from a vehicle security apparatus. In the above portable device, for instance, the vehicle security apparatus may determine that the relevant portable device (key) corresponds to the authorized portable device based upon the identification signal transmitted from the portable device (key), and then, may set the immobilizer when a shift lever is set to a parking range and an engine switch (push button) is manipulated.

Also, when a user holding the portable device rides a vehicle, the vehicle security apparatus may transmit a request signal. If the vehicle security apparatus determines that the portable device held by the user is the authorized device by identifying an identification signal which is contained in a response signal resent from the portable device, then this vehicle security apparatus may unset the immobilizer. It should also be understood that setting/unsetting operations of the immobilizer in a case that the portable device is employed as an electronic key are not limited to the disclosed construction and operation.

Also, in place of the cellular phone 70 employed in order to communicate with the base station 50, a home phone set installed in a home may be employed.

Further, although the vehicle security apparatus 10 is equipped with the immobilizer ECU 11, the antenna 11a, the remote security ECU 12, the communication ECU 13, and the antenna 13a. However, the vehicle security apparatus may be equipped with a key communication unit for communicating with the key 40, a remote communication unit for communicating with the base station 50, and a control unit. This control unit may control prohibition and/or permission of a drive operation of an engine based upon an identification signal transmitted to the key communication unit, and both a remote set signal and a remote unset signal, which are transmitted to the remote communication unit. For example, the vehicle security apparatus 10 may be realized as such a control apparatus equipped with the key communication unit, the remote communication unit, and the control unit.

1. A vehicle security apparatus capable of communicating with an electronic key and a communication apparatus, the electronic key transmitting a specific identification signal, and the communication apparatus being located at a remote place and transmitting drive request signals indicative of a drive prohibition request and a drive permission request to a drive power apparatus of a vehicle, the vehicle security apparatus comprising:
key communication means for communicating with the electronic key;
remote communication means for communicating with the communication apparatus located at the remote place;
travel condition detecting means for detecting a travel condition of the vehicle; and
control means for controlling prohibition and permission of a drive operation of the power apparatus based upon the identification signal transmitted to the key communication means, the drive request signal transmitted to the remote communication means, and the travel condition of the vehicle,
wherein the control means executes a remote drive prohibition control operation for prohibiting drive permission of the power apparatus based upon the identification signal until the drive request signal indicating the drive permission request is transmitted to the remote communication means based on an execution condition that a detection result of the travel condition detecting means indicates a completion of the traveling operation of the vehicle, when the drive request signal indicating the drive permission request is transmitted to the remote communication means.

2. The vehicle security apparatus as in claim 1, wherein:
the travel condition detecting means detects whether the drive operation of the power apparatus is prohibited based upon the identification signal to detect the travel condition of the vehicle; and
the execution condition includes that the drive operation of the power apparatus is prohibited based upon the identification signal.

3. The vehicle security apparatus as in claim 1, wherein:
the travel condition detecting means detects whether a predetermined time has elapsed after the drive operation of the power apparatus had prohibited based upon the identification signal so as to detect the travel condition of the vehicle; and
the execution condition includes that the predetermined time has elapsed after the drive operation of the power apparatus has been prohibited based upon the identical signal.

4. The vehicle security apparatus as in claim 1, wherein:
the travel condition detecting means includes a theft preventing apparatus, which generates a theft warning when a theft of the vehicle is detected under a condition that the drive operation of the power apparatus is stopped, and sets the theft warning when a predetermined time has elapsed after the drive operation of the power apparatus had been stopped;
the travel condition detecting means detects whether the theft warning is set to detect the travel condition of the vehicle; and
the execution condition includes that the theft warning is set by the theft preventing apparatus.

5. The vehicle security apparatus as in claim 1, wherein:
the travel condition detecting means includes a theft preventing apparatus, which generates a theft warning when a theft of the vehicle is detected under a condition that the drive operation of the power apparatus is stopped;
the travel condition detecting means detects whether the theft warning is generated to detect the travel condition of the vehicle; and
the execution condition includes that the theft warning is generated by the theft preventing apparatus.

6. The vehicle security apparatus as in claim 1, wherein:
the travel condition detecting means detects a condition of an electric power supply and checks whether a predetermined time has elapsed after a power supply condition had become ACC to detect the travel condition of the vehicle; and
the execution condition includes that the predetermined time has elapsed after the power supply condition had become ACC.

7. The vehicle security apparatus as in claim 1, wherein:
the travel condition detecting means detects a locking condition of a steering wheel and checks whether the locking condition of the steering wheel is set to detect the travel condition of the vehicle; and
the execution condition includes that the locking condition of the steering wheel is set.

8. The vehicle security apparatus as in claim 1, wherein:
the travel condition detecting means detects a condition of a battery and checks whether the battery is disconnected from the vehicle and then again connected to the vehicle to detect the travel condition of the vehicle; and
the execution condition includes that the battery is disconnected from the vehicle and then is again connected to the vehicle.

9. The vehicle security apparatus as in claim 1, wherein:
the control means brings execution of the remote drive prohibition control into a wait state, when the drive request signal indicating the drive prohibition request is transmitted to the remote communication means under a condition that the power apparatus is permitted to be driven based upon the identification signal; and
the control means executes the remote drive prohibition control at a time instant when the execution condition is satisfied under the wait state.

10. The vehicle security apparatus as in claim 9, wherein:
the control means releases the wait state, when the drive request signal indicating the drive permission request is transmitted to the remote communication means under the wait state.

11. The vehicle security apparatus as in claim 1, wherein:
the control means executes the remote drive prohibition control at a time instant when the drive request signal indicating the drive permission request is transmitted to the remote communication means, in a case that the drive request signal indicating the drive permission request is transmitted to the remote communication means under the execution condition is satisfied.

12. The vehicle security apparatus as in claim 1, wherein:
the control means includes a local control unit into which both the identification signal from the key communication means and the detection result made by the drive condition detecting means are inputted, and a remote control unit into which the drive request signal is inputted from the remote communication means;
the remote control unit outputs the drive request signal to the local control unit; and
the local control unit controls the prohibition and permission of the drive operation of the power apparatus based upon the identification signal, the drive request signal and the detection result of the travel condition detecting means.

13. A vehicle security system comprising:
an electronic key that is portable and transmits a specific identification signal;
a communication apparatus that transmits drive request signals, which indicate a drive prohibition request and a drive permission request to a power apparatus of a vehicle, to remote-control the power apparatus; and
the vehicle security apparatus recited in claim 1.
